(19) United States
(12) Patent Application Publication
(10) Pub. No.: US 2009/0136094 A1
(43) Pub. Date: May 28, 2009

(54) Systems And Methods For Patient Identification Using Mobile Face Recognition

(75) Inventors: Tushad Percy Driver, Streamwood, IL (US); Senthilnathan Sundaram, Vernon Hills, IL (US); Govind Khandelwal, Hoffman Estates, IL (US); Maneesha Sahasrabudhe, Chicago, IL (US)

Correspondence Address: MCANDREWS HELD & MALLOY, LTD, 500 WEST MADISON STREET, SUITE 3400, CHICAGO, IL, 60661, US

(73) Assignee: GENERAL ELECTRIC COMPANY, Schenectady, NY (US)

(21) Appl. No.: 11/945,108

(22) Filed: Nov. 26, 2007

(51) Int. Cl. G06K 9/00

(52) U.S. Cl. 382/115

(57) ABSTRACT

Certain embodiments of the present invention provide a patient identifier system including an image capture component adapted to capture a patient image, an image lookup component adapted to compare the patient image to a plurality of stored images to identify a matching image, and a record retrieval component adapted to retrieve medical data using patient data associated with the matching image. The patient image is an image of a patient. Each stored image is associated with patient data.

### BACKGROUND OF THE INVENTION

The present invention generally relates to patient identification. More particularly, the present invention relates to systems and methods for patient identification using mobile face recognition.

Healthcare has become increasingly centered around electronic data and records management. Healthcare environments, such as hospitals or clinics, include medical information systems, such as healthcare information systems (HIS), radiology information systems (RIS), clinical information systems (CIS), and cardiovascular information systems (CVIS), and storage systems, such as picture archiving and communication systems (PACS), library information systems (LIS), and electronic medical records (EMR). Information stored may include medical data, such as medical records, patient medical histories, imaging data, test results, diagnosis information, scheduling information, insurance information, and/or contact information, for example. The information for a particular information system may be centrally stored or divided at a plurality of locations.

Healthcare practitioners may desire to access patient information or other information at various points in a healthcare workflow, using devices such as a mobile phone, a personal digital assistant (PDA), a tablet personal computer (Tablet PC), or a computer, for example.

In order to access a patient's records stored in a medical information system or a storage system, a healthcare practitioner may obtain information to identify the patient. As an example, a healthcare practitioner may obtain the patient's name or identification number. The patient's name or identification number may be used to identify the patient, for example. Current methods of identification include consulting the patient, a nameplate, an identification bracelet, or a medical chart; scanning a bar code on an identification bracelet; and employing an antenna to detect radio-frequency identification (RFID) tags embedded in the patient's clothing.

Several difficulties may arise when a healthcare practitioner attempts to obtain a patient's name or identification number. The patient may not remember or may be unable to communicate the information, for example. The healthcare practitioner may be unable to find, see, or read the patient's nameplate, identification bracelet, or medical chart. The patient may switch to a bed with an incorrect nameplate or identification bracelet. A bar-code scanner may be unable to read a bar code on an identification bracelet. The patient's bar code may be difficult to access. The patient's identification bracelet may fall off or be removed accidentally. The patient's RFID tagged clothing may be switched inadvertently with the clothing of another patient.

Once a healthcare practitioner has obtained a patient's name or identification number, the practitioner must manually input the name or number into a device or select the name or number from a list displayed by the device to access the patient's medical data. The healthcare practitioner may input the identifying information incorrectly, thus causing the practitioner to retrieve the wrong records. Additionally, multiple patients may have the same name, thus causing the healthcare practitioner to obtain the wrong records.

### BRIEF SUMMARY OF THE INVENTION

Certain embodiments of the present invention provide a method of patient identification including capturing a patient image, comparing the patient image to a plurality of stored images to determine a matching image, and selecting patient data associated with the matching image. The patient image is an image of a patient. Each stored image is associated with patient data.

Certain embodiments of the present invention provide a patient identifier system including an image capture component adapted to capture a patient image, an image lookup component adapted to compare the patient image to a plurality of stored images to identify a matching image, and a record retrieval component adapted to retrieve medical data using patient data associated with the matching image. The patient image is an image of a patient. Each stored image is associated with patient data.

Certain embodiments of the present invention provide a computer-readable medium including a set of instructions for execution on a computer, the set of instructions including an image lookup routine and a record retrieval routine. The image lookup routine is configured to compare a patient image to a plurality of stored images to select a matching image. The patient image is an image of a patient. Each stored image is associated with patient data. The record retrieval routine is configured to retrieve medical data using the patient data associated with the matching image.

Certain embodiments of the present invention provide a computer-readable medium including a set of instructions for execution on a computer, the set of instructions including an image capture routine and a data display routine. The image capture routine is configured to capture a patient image and to transmit the patient image to an image lookup component. The patient image is an image of a patient. The image lookup component is adapted to compare the patient image to a plurality of stored images to identify a matching image. Each stored image is associated with patient data. The data display routine is configured to receive and display medical data of the patient. The medical data is received from a record retrieval component adapted to retrieve the medical data using the patient data associated with the matching image.

### BRIEF DESCRIPTION OF SEVERAL VIEWS OF THE DRAWINGS

FIG. 1 illustrates a patient identifier system in accordance with an embodiment of the present invention.

FIG. 2 illustrates a patient identifier system in accordance with an embodiment of the present invention.

FIG. 3 illustrates a flow diagram for a method for patient identification in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentalities shown in the attached drawings.

### DETAILED DESCRIPTION OF THE INVENTION

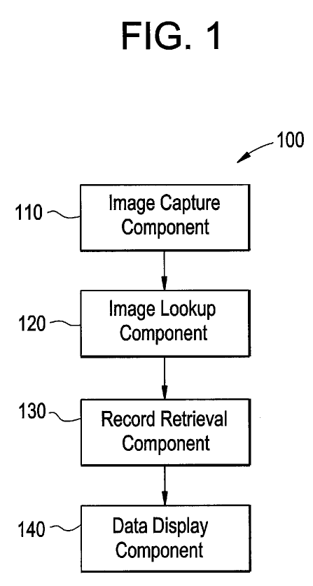

FIG. 1 illustrates a patient identifier system 100 in accordance with an embodiment of the present invention. The system 100 includes an image capture component 110, an image lookup component 120, a record retrieval component 130, and a data display component 140.

The image capture component 110 is in communication with the image lookup component 120. The image lookup component 120 is in communication with the record retrieval component 130. The record retrieval component 130 is in communication with the data display component 140.

In operation, the image capture component 110 captures a patient image, which is an image of a patient. The patient image is then transmitted to the image lookup component 120. The image lookup component 120 includes or is in communication with memory storing a plurality of stored images. Each stored image includes an image of a patient and may be associated with patient data of the patient in the stored image. When an image is associated with data, such as patient data or medical data, for example, the image may be stored in a file containing the data or a link to the location of the data, for example. After receiving the patient image, the image lookup component 120 uses a face-recognition program to compare the captured patient image to the plurality of stored images. The image lookup component 120 may select a matching image from the plurality of stored images. Then, the image lookup component 120 may transmit the patient data associated with the matching image to the record retrieval component 130.

The record retrieval component 130 receives the patient data associated with the matching image. The record retrieval component 130 may be in communication with at least one of a medical information system and a storage system. The record retrieval component 130 may use the received patient data associated with the matching image to identify medical data stored in the at least one of a medical information system and a storage system to which the record retrieval component 130 has access. The record retrieval component 130 may transmit the identified medical data associated with the patient data to the data display component 140. Then, the data display component 140 may display the medical data.

When components are in communication with one another, they may communicate using wired or wireless connections. For example, the components may communicate utilizing the Internet, a public telephone network, a dedicated communication line, a virtual private network (VPN), a secure network, and/or an intranet. The components also may follow a selected protocol to communicate, such as hypertext transfer protocol (HTTP), file transfer protocol (FTP), transmission control protocol/internet protocol (TCP/IP), .Net protocol, or Java protocol, for example.

Alternatively, some or all of the components may be part of the same application. For example, the image capture component 110, the image lookup component 120, and the data display component 140 may be part of the same application. As another example, the image capture component 110 and the data display component 140 may be part of the same application. As another example, the image lookup component 120 and the record retrieval component 130 may be part of the same application. As another example, the image capture component 110, the image lookup component 120, the record retrieval component 130, and the data display component 140 may be part of the same application. As another example, the image capture component 110, the image lookup component 120, and the record retrieval component 130 may be part of the same application.

The image capture component 110 may be a mobile phone, a PDA, a tablet personal computer (Tablet PC), and a digital camera, for example. The image capture component 110 may have a built-in digital camera. Alternatively, a digital camera may connect to the image capture component 110 through a port, such as a universal serial bus (USB) port, for example, to include the image capture component 110.

The patient image may include an image depicting at least a portion of the patient's body. For example, the patient image may include an image depicting at least the patient's face.

The image capture component 110 may include or be in communication with memory to store the captured patient image.

In certain embodiments, the image capture component 110 may display the patient image after the image is captured or while capturing the image, for example. In certain embodiments, the image capture component 110 is integrated with the data display component 140. In other embodiments, the data display component 140 is a separate module in the patient identifier system 100, and may be in communication with the image capture component 110. The data display component 140 may display the patient image after the patient image is captured or while the image capture component 110 is capturing the patient image, for example.

In certain embodiments, the image lookup component 120 is integrated with the image capture component 110. In certain embodiments, the image lookup component 120 is integrated with the record retrieval component 130. The image lookup component 120 also may be a separate module in the patient identifier system 100.

The image lookup component 120 may include a server, for example. In another embodiment, the image lookup component 120 may include a series of networked servers. The image lookup component 120 may also include a laptop computer, a Tablet PC, or a PDA. The image lookup component 120 may run a face-recognition program, such as a face-recognition program in current use. For example, software available from Sensible Vision, Inc., 40376 Blue Star Highway #11, Covert, Mich. 49043, may include the face-recognition program.

The face-recognition program may be implemented using software, hardware, and/or firmware. The face-recognition program may identify traits in the patient image and the plurality of stored images. The traits may include the distance between any two points on a face in an image, such as the distance between two eyes, two ears, or the sides of the nose; or the shape of any element in an image, such as a nose, ear, eye, lip, chin line, eye-socket, or cheekbone, for example. The face-recognition program may identify the matching image by comparing the traits identified in the patient image to the traits identified in the plurality of stored images. The matching image may be the stored image which most closely resembles the patient image according to the trait comparison, within a margin of error.

A patient image may be a two-dimensional image or a three-dimensional image. Similarly, a stored image may be a two-dimensional image or a three-dimensional image. Each stored image may be an image of a patient. The stored image may be associated with patient data of the patient in the stored image. The patient data may include a patient name, a patient identification number, at least one link to medical data, and/or at least one medical record, for example. The link may be, for example, a URL, a path name, or another representation of the location of the medical data.

In an embodiment, multiple stored images may be associated with the same patient data. The face-recognition program may identify a group of matching images associated with the same patient data, wherein the group most closely resembles the captured patient image after comparing the traits in the images. Alternatively, the group of images may be used to improve the likelihood of a good match.

In certain embodiments, the record retrieval component 130 is not present. In certain embodiments, the image lookup component 120 may be in communication with the data display component 140. The image lookup component 120 may transmit the patient data associated with the matching image to the data display component 140. Alternatively, the record retrieval component 130 may transmit the patient data associated with the matching image to the data display component 140. Thus, the data display component 140 may display the patient data. For example, the data display component 140 may display the patient's name. As another example, the data display component 140 may display at least one of the patient's medical records.

In some embodiments, the record retrieval component 130 is a separate module. The record retrieval component 130 may include a server in communication with at least one of a medical information system and a storage system, wherein each system may store medical data. Alternatively, the record retrieval component 130 may include a series of networked servers. The medical data may include medical records, patient medical histories, imaging data, test results, diagnosis information, scheduling information, insurance information, and/or contact information, for example.

The data display component 140 may display the medical data to a user. The user may be a doctor, a nurse, or another healthcare practitioner, for example. The data display component 140 may include a mobile phone, a PDA, a Tablet PC, a laptop computer, or a desktop computer, for example.

In another embodiment, the record retrieval component 130 may transmit to the data display component 140 at least one link to the retrieved medical data instead of or in addition to transmitting the retrieved medical data. That is, the record retrieval component 130 may provide a link to the medical data to the data display component 140 rather than the medical data itself. The link may be, for example, a URL, a path name, or another representation of the location of the medical data. A link or multiple links may be displayed on the data display component 140. A user of the data display component 140 may review and/or select each displayed link to access or download the information from a medical information system or a storage system, for example.

In certain embodiments, the data display component 140 may also include a user interface component which allows a user to manipulate the medical data and the patient data. The user may manipulate the medical data or the patient data by editing the data, deleting the data, rearranging the data, or adding to the data, for example.

In certain embodiments, the image lookup component 120 may be unable to select the matching image. There may not be an image of the patient in the plurality of stored images, the patient image may be unclear, or objects may obscure the patient in the patient image. For example, the patient may be a new patient; a lens of the image capture component 110 may be scratched; or the patient's face may be covered in bandages, burned, or obscured by oxygen tubes. The image lookup component 120 may then transmit a signal to the data display component 140 to display a message indicating that the patient image was not matched and requesting that a user input the patient data of the patient in the patient image, such as a patient name or a patient identification number. The user may input the patient data using the user interface component on or in communication with the data display component 140. The user interface component may include a keyboard, a mouse, a touch pad, and/or a bar-code scanner, for example. The data display component 140 may transmit the patient data to the image lookup component 120. The image lookup component 120 may transmit the patient data to the record retrieval component 130. Thus, the record retrieval component 130 may use the patient data to retrieve medical data associated with the patient data.

The components, elements, and/or functionality of the interface(s) and system(s) described above may be implemented alone or in combination in various forms in hardware, firmware, and/or as a set of instructions in software, for example. Certain embodiments may be provided as a set of instructions residing on a computer-readable medium, such as a memory or hard disk, for execution on a general purpose computer or other processing device, such as, for example, one or more dedicated processors.

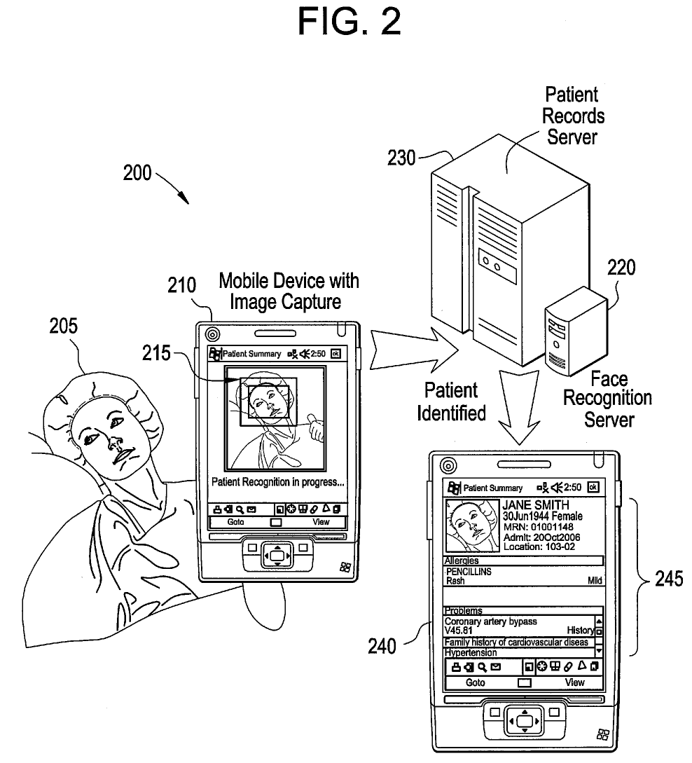

FIG. 2 illustrates a patient identifier system 200 in accordance with an embodiment of the present invention. The system 200 includes a patient 205, an image capture component 210, a patient image 215, an image lookup component 220, a record retrieval component 230, a data display component 240, and patient medical data 245.

The image capture component 210 may capture the patient image 215 of the patient 205. The image capture component 210 is in communication with the image lookup component 220. The image lookup component 220 is in communication with the record retrieval component 230. The record retrieval component 230 is in communication with the data display component 240. The data display component 240 may display the patient medical data 245.

In operation, the image capture component 210 captures the patient image 215, wherein the patient image 215 is an image of the patient 205. The image capture component 210 displays the patient image 215. The patient image 215 is then transmitted to the image lookup component 220. The image lookup component 220 includes or is in communication with memory storing a plurality of stored images. Each stored image contains an image of a patient and may be associated with patient data of the patient in the stored image. The image lookup component 220 uses a face-recognition program to compare the captured patient image 215 to the plurality of stored images. Using the results of the comparison, the image lookup component 220 may select a matching image from the plurality of stored images. Then, the image lookup component 220 may transmit the patient data associated with the matching image to the record retrieval component 230. The patient data may be the patient data of the patient 205.

The record retrieval component 230 may receive the patient data associated with the matching image. The record retrieval component 230 may be in communication with at least one of a medical information system and a storage system. The record retrieval component 230 may use the patient data associated with the matching image to identify the patient medical data 245 stored in the at least one of a medical information system and a storage system. The patient medical data 245 may be associated with the patient data. The record retrieval component 230 may transmit the patient medical data 245 to the data display component 240.

The data display component 240 may display the patient medical data 245. The patient medical data 245 may include, for example, the medical records, medical histories, imaging data, test results, diagnosis information, scheduling information, insurance information, and/or contact information of the patient 205.

The patient data may be similar to the patient data described above in reference to FIG. 1. The image capture component 210 may be similar to the image capture component 110 described above. The image lookup component 220 may be similar to the image lookup component 120 described above. The record retrieval component 230 may be similar to the record retrieval component 130 described above. Additionally, the data display component 240 may be similar to the data display component 140 described above.

The patient 205 is a person the healthcare practitioner is trying to identify. The patient 205 may be a person receiving care from a healthcare practitioner, such as a nurse or a doctor, for example. The patient image 215 may include an image depicting at least a portion of the patient 205. For example, the patient image may include an image depicting at least a face of the patient 205. The image capture component 210 may store the captured patient image 215.

The components, elements, and/or functionality of the interface(s) and system(s) described above may be implemented alone or in combination in various forms in hardware, firmware, and/or as a set of instructions in software, for example. Certain embodiments may be provided as a set of instructions residing on a computer-readable medium, such as a memory or hard disk, for execution on a general purpose computer or other processing device, such as, for example, one or more dedicated processors.

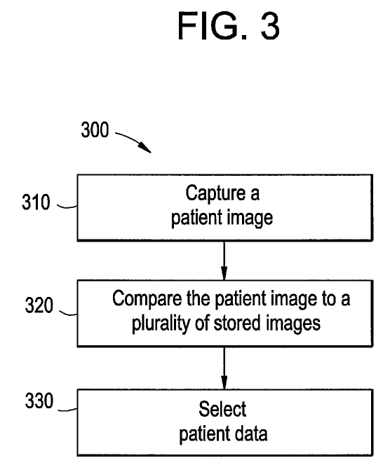

FIG. 3 illustrates a flow diagram for a method 300 for patient identification in accordance with an embodiment of the present invention. The method 300 includes the following steps, which will be described below in more detail. At step 310, a patient image is captured. At step 320, the patient image is compared to a plurality of stored images. At step 330, patient data is selected. The method 300 is described with reference to elements of systems described above, but it should be understood that other implementations are possible.

At step 310, the patient image is captured. A user, such as a nurse, a doctor, or another healthcare practitioner, may capture the patient image, which is an image of a patient, using an image capture component. The patient image may be similar to the patient image 215, as described above. The patient may be similar to the patient 205 described above. The image capture component may be similar to the image capture component 110 and the image capture component 210, as described above, for example.

At step 320, the patient image is compared to a plurality of stored images. Each stored image may contain an image of a patient and may be associated with patient data of the patient in the stored image. An image lookup component may be used to compare the captured patient image to the plurality of stored images. The image lookup component may be similar to the image lookup component 120 and the image lookup component 220, as described above, for example. The image lookup component includes or is in communication with memory storing the plurality of stored images. The image lookup component may use a face-recognition program to perform the comparison. As a result of the comparison, a matching image is selected from the plurality of stored images.

At step 330, the patient data is selected. The selected patient data is the patient data associated with the matching image. That is, the selected patient data is the patient data of the patient in the matching image.

The face-recognition program may be similar to the face-recognition program described above in reference to FIGS. 1 and 2. For example, the face-recognition program may be implemented using software, hardware, and/or firmware. The face-recognition program may identify traits in the patient image and the plurality of stored images. The traits may include the distance between any two points on a face in an image, such as the distance between two eyes, two ears, or the sides of the nose; or the shape of any element in an image, such as a nose, ear, eye, lip, chin line, eye-socket, or cheekbone, for example. The face-recognition program may identify the matching image by comparing the traits identified in the patient image to the traits identified in the plurality of stored images. The matching image may be the stored image which most closely resembles the patient image according to the trait comparison, within a margin of error.

Each stored image may be similar to the stored images described above in reference to FIGS. 1 and 2. Additionally, the patient data may be similar to the patient data described above in reference to FIGS. 1 and 2.

The method 300 may be implemented at a variety of points in the healthcare workflow. For example, a healthcare practitioner may implement method 300 while rounding on patients, administering medications to patients, feeding patients, performing pre-operative and post-operative checks on patients, transferring patients, and checking patients in and out of a healthcare facility, for example.

In certain embodiments, the method 300 may perform an additional step of retrieving medical data using the patient data. The medical data may be retrieved using a record retrieval component similar to the record retrieval component 130 and the record retrieval component 230 described above, for example. The medical data may be retrieved from at least one of a medical information system and a storage system, which are in communication with the record retrieval component. The patient data associated with the matching image may be used to identify the patient's medical data stored in the at least one of a medical information system and a storage system. The medical data may be similar to the medical data 245 described above, for example.

In certain embodiments, the method 300 may perform an additional step of displaying the medical data. The record retrieval component may transmit the patient data, and the medical data or links to the medical data to a data display component, which may be similar to the data display component 140 and the data display component 240 described above. The data display component may display the medical data or links to the medical data.

In certain embodiments, the method 300 may perform an additional step of displaying selected data. The image lookup component may transmit the patient data to the data display component. The user may select which medical data and patient data to display on the data display component. To make the selection, the user may use a user interface component in communication with or integrated with the data display component.

In certain embodiments, the method 300 may perform an additional step of storing the patient image. The image lookup component may store the patient image with the plurality of stored images in the memory on the image lookup component or in communication with the image lookup component. The image lookup component may associate the selected patient data with the stored patient image.

In certain embodiments, the method 300 may perform the additional step of updating the matching image. The image lookup component may delete the matching image from the plurality of stored images and store the patient image with the plurality of stored images. The image lookup component may also associate the selected patient data with the stored patient image.

In certain embodiments, at step 310, a plurality of patient images of the same patient may be captured. In such embodiments, at step 320, the plurality of patient images may be compared to the plurality of stored images.

In certain embodiments, the image lookup component may select either a matching image or a plurality of matching images from the plurality of stored images, wherein the plurality of matching images is associated with the same patient data. In those embodiments, at step 330, the image lookup component may select the patient data associated with the matching image or the plurality of matching images.

In an embodiment, at step 320, the image lookup component may be unable to select at least one matching image. There may not be an image of the patient in the plurality of stored images, the patient image may be unclear, or objects may obscure the patient in the patient image. For example, the patient may be a new patient; a lens of the image capture component may be scratched; or the patient's face may be covered in bandages, burned, or obscured by oxygen tubes. The image lookup component may then transmit a signal to the data display component to display a message indicating that the patient image was not matched and requesting that a user input the patient data of the patient in the patient image, such as a patient name or a patient identification number. The user may input the patient data using the user interface component on or in communication with the data display component. The user interface component may include a keyboard, a mouse, a touch pad, and/or a bar-code scanner, for example. The data display component may transmit the patient data to the image lookup component. The image lookup component may transmit the patient data to the record retrieval component. Thus, the record retrieval component may use the patient data to retrieve medical data associated with the patient data.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

One or more of the steps of the method 300 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Thus, certain embodiments of the present invention provide a method for patient identification. Further, certain embodiments of the present invention provide for a patient identifier system that is adapted to obtain patient data and medical data using a captured patient image. Certain embodiments obtain the patient data and/or the medical data of a patient using an image of the patient. Certain embodiments provide a technical effect of retrieving patient data and/or medical data of a patient using an image of the patient.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

Several embodiments are described above with reference to drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems and program products on any machine-readable media for accomplishing its operations. As noted above, the embodiments of the present invention may be implemented using an existing computer processor, or by a special purpose computer processor incorporated for this or another purpose or by a hardwired system.

As noted above, certain embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Certain embodiments of the invention are described in the general context of method steps which may be implemented in one embodiment by a program product including machine-executable instructions, such as program code, for example in the form of program modules executed by machines in networked environments. Generally, program modules include routines, programs, objects, components, data structures, etc., that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

Certain embodiments of the present invention may be practiced in a networked environment using logical connections to one or more remote computers having processors. Logical connections may include a local area network (LAN) and a wide area network (WAN), which are presented here by way of example and not limitation. Such networking environments are commonplace in office-wide or enterprise-wide computer networks, intranets, and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules, and other data for the computer.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

Those skilled in the art will appreciate that the embodiments disclosed herein may be applied to the formation of any patient identifier. Certain features of the embodiments of the claimed subject matter have been illustrated as described herein; however, many modifications, substitutions, changes and equivalents will now occur to those skilled in the art. Additionally, while several functional blocks and relations between them have been described in detail, it is contemplated by those of skill in the art that several of the operations may be performed without the use of the others, or additional functions or relationships between functions may be established and still be in accordance with the claimed subject matter. It is, therefore, to be understood that the appended claims are intended to cover all such modifications and changes as fall within the true spirit of the embodiments of the claimed subject matter.

1. A method of patient identification, the method comprising:
capturing a patient image, wherein the patient image is an image of a patient;
comparing the patient image to a plurality of stored images to determine a matching image, wherein each stored image is associated with patient data; and
selecting the patient data associated with the matching image.

2. The method of claim 1, wherein the patient image comprises an image of a face of the patient.

3. The method of claim 1, further comprising retrieving medical data using the patient data.

4. The method of claim 3, further comprising displaying the medical data.

5. The method of claim 1, further comprising:
storing the patient image with the plurality of stored images; and
associating the stored patient image with the selected patient data.

6. The method of claim 1, wherein the patient data comprises at least one of a patient identification number and a patient name.

7. The method of claim 1, further comprising displaying the patient data.

8. The method of claim 1, wherein the capturing step is performed by an image capturing component.

9. The method of claim 1, wherein the comparing step is performed by an image lookup component.

10. A patient identifier system, the system comprising:
an image capture component adapted to capture a patient image, wherein the patient image is an image of a patient;
an image lookup component adapted to compare the patient image to a plurality of stored images to identify a matching image, wherein each stored image is associated with patient data; and
a record retrieval component adapted to retrieve medical data using the patient data associated with the matching image.

11. The system of claim 10, wherein the patient image comprises an image of a face of the patient.

12. The system of claim 10, wherein the image capture component comprises at least one of a mobile phone, a personal digital assistant, a tablet personal computer, and a digital camera.

13. The system of claim 10, further comprising a data display component adapted to display the medical data.

14. The system of claim 13, wherein the data display component is integrated with the image capture component.

15. The system of claim 13, wherein the data display component is adapted to display the captured patient image.

16. The system of claim 10, wherein the patient data is at least one of a patient identification number and a patient name.

17. The system of claim 10, wherein the patient image is a two-dimensional image.

18. The system of claim 10, wherein the patient image is a three-dimensional image.

19. A computer-readable medium comprising a set of instructions for execution on a computer, the set of instructions comprising:
an image lookup routine configured to compare a patient image to a plurality of stored images to select a matching image, wherein the patient image is an image of a patient, wherein each stored image is associated with patient data; and
a record retrieval routine configured to retrieve medical data using the patient data associated with the matching image.

20. A computer-readable medium comprising a set of instructions for execution on a computer, the set of instructions comprising:
an image capture routine configured to capture a patient image and to transmit the patient image to an image lookup component, wherein the patient image is an image of a patient, wherein the image lookup component is adapted to compare the patient image to a plurality of stored images to identify a matching image, wherein each stored image is associated with patient data; and
a data display routine configured to receive and display medical data of the patient, wherein the medical data is received from a record retrieval component adapted to retrieve the medical data using the patient data associated with the matching image.
